(19) United States
(12) Patent Application Publication
(10) Pub. No.: US 2015/0278959 A1
(43) Pub. Date: Oct. 1, 2015

(54) LEVERAGING MULTIDIMENSIONAL MEASUREMENT BASIS IN TRANSACTIONAL SYSTEMS

(71) Applicant: Microsoft Corporation, Redmond, WA (US)

(72) Inventors: Arthur Greef, Burien, WA (US); Michael Gall, Copenhagen (DK); Xavier Chape, Stenlose (DK); John Healy, Fargo, ND (US); Par Akerblom, North Bend, WA (US)

(73) Assignee: Microsoft Corporation, Redmond, WA (US)

(21) Appl. No.: 14/227,958

(22) Filed: Mar. 27, 2014

(51) Int. Cl. G06Q 40/00

(52) U.S. Cl. CPC G06Q 40/12

(57) ABSTRACT

Technologies are generally described to leverage a multidimensional measurement basis for cost accounting in a cost accounting system to increase cohesion of the system. One or more scales for units of measure may be defined based on a magnitude of product cost and a product cost measure determined by various subsystems of the cost accounting system. The magnitude of product cost may be determined based on a cost object unit, a cost element unit, a date and time unit, and a quantity unit, and the product cost measure may be determined based on a cost base and a unit cost. The scales defined may be applied to cost accounting in a reporting ledger of the cost accounting system and a report may be generated from the reporting ledger that enables cost analysis based on the scales defined.

### BACKGROUND

Transactional systems such as cost accounting systems may track data associated with various transactions in a transaction document, and may process the transaction document to generate a detailed subsidiary journal entry and a summarized general ledger entry. For example, in a cost accounting system, transaction documents such as purchase orders, receiving reports, and vendor invoices, may document operational consequences of one or more transaction events in terms of quantity of resources. The quantities may be transferred and processed for recognition in subsidiary journal entries as economic consequences of the transaction events. At an end of a period, or else perpetually, the subsidiary journal entries may then be transferred to a general ledger account entry, for reporting of the economic consequences.

Some challenges with traditional transaction systems may include a lack of common and coherent measurement basis with operations that may be used to interpret and exploit measurements from the transaction documents through subsidiary journal entries and general ledger entries. As a result, consequences of a transaction event, such as cost, may be classified and recorded in the subsidiary journal and general ledger using specific and limited sets of attributes and measurement characteristics that are loosely related one to another at each stage, which may limit traceability from the transaction event to its consequence.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to leveraging a multidimensional measurement basis for cost accounting in a cost accounting system to increase cohesion of the system. One or more scales for units of measure may be defined based on a magnitude of product cost and a product cost measure determined by various subsystems of the cost accounting system. The magnitude of product cost may be determined based on a cost object unit, a cost element unit, a date and time unit, and a quantity unit, and the product cost measure may be determined based on a cost base and a unit cost. The scales defined may be applied to cost accounting in a reporting ledger of the accounting system, and a report may be generated from the reporting ledger that enables cost analysis based on the scales defined.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example cloud based environment where a transactional data system may be implemented;

FIG. 2 illustrates an example cost accounting subsystem where a magnitude of product cost may be determined;

FIG. 3 illustrates an example of a cost accounting system where multidimensional measurement basis may be leveraged for cost accounting employing one or more subsystems;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process to leverage a multidimensional measurement basis for cost accounting, according to embodiments.

### DETAILED DESCRIPTION

As briefly described above, a multidimensional measurement basis may be leveraged for cost accounting in a cost accounting system to increase cohesion of the system. One or more scales for units of measure may be defined based on a magnitude of product cost and a product cost measure determined by various subsystems of the cost accounting system. The magnitude of product cost may be determined based on a cost object unit, a cost element unit, a date and time unit, and a quantity unit, and the product cost measure may be determined based on a cost base and a unit cost. The scales defined may be applied to cost accounting in a reporting ledger of the cost accounting system, and a report may be generated from the reporting ledger that enables cost analysis based on the scales defined.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for leveraging a multidimensional measurement basis for cost accounting. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

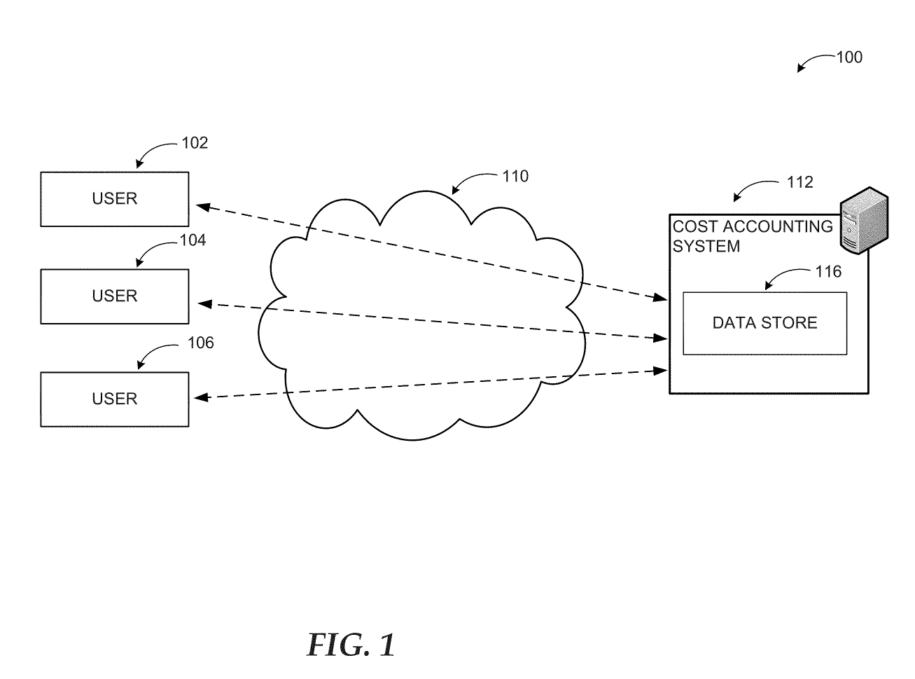

FIG. 1 illustrates an example cloud based environment where a transactional data system may be implemented, according to some embodiments herein.

As illustrated in a diagram 100, a transactional data system, such as a cost accounting system 112, may be accessed by multiple users (e.g. users 102, 104, 106) over a network such as a cloud based network 110. An example cost accounting system 112 may provide tracking, recording, and retention or storage of data associated with an entity, organization, or system, such as a business enterprise. The cost accounting system 112 may be operated locally on one or more computing devices of the organization. In another embodiment, the cost accounting system 112 may be provided as a cloud-hosted application to an organization, and may be provided over the cloud based network 110 to one or more computing devices where it may be locally accessed and interacted with as a locally installed application.

Some example transactions that may be tracked and retained by the cost accounting system 112 may include financial transactions such as orders, invoices, and payments, and accounting transactions. The transactions may be received from one or more source documents such as a purchase order, an invoice, a receipt, a shipping order, a receiving report, and an inventory list, and characterized in one or more dimensions. The source documents may be provided to the cost accounting system 112 by the users (e.g., the users 102, 104, 106) through a document entry user interface that provides data entry fields or via a web-browser enabled form that accepts data entry and enables indirect and direct access to the source document by the cost accounting system 112. Recorded transactions may be stored in a data store 116 associated with the cost accounting system 112. The data store 116 may enable retention of raw data associated with transactions, and may also store transaction documents associated with various tracked transactions to enable data accessibility and analysis. The data store may store the data, for example, in tables, databases, lists, text files, or any other data format suitable for the cost accounting system 112.

The multidimensional characterized data may be used to in the determination of a magnitude of product cost and a product measure. The determined magnitude of product cost and the product measure may be used to define one or more scales for units of measure that may be applied to cost accounting in one or more ledgers of the cost accounting system 112. The defined scales may enable uniform multidimensional measurements to be used throughout the cost accounting system 112 as data associated with the transactions is transferred from the source documents, to event chains, to a sub ledger journal, and to the general ledger to be characterized and quantified. The general ledger may generate comprehensive data reports for data analysis, such as cost reports for cost analysis, based on the transaction data using the uniform multidimensional measurements, which may assist in meeting reporting regulation requirements. For example, using the uniform multidimensional measurements may enable a traceability from the transaction event at the source documents to its cost characterized and quantified in the general ledger. Additionally, the uniform multidimensional measurements may be implemented in an application framework that can be shared by all documents and processes, which may lower a cost and complexity of extending the application to new domains.

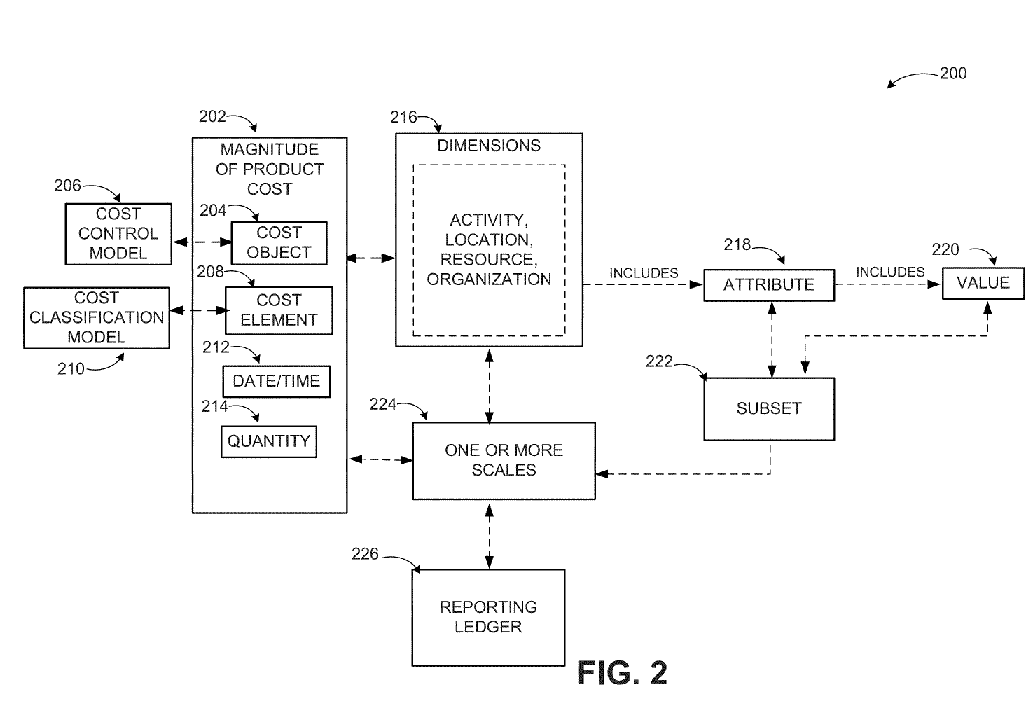

FIG. 2 illustrates an example cost accounting subsystem where a magnitude of product cost may be determined, according to some embodiments herein.

As discussed previously in FIG. 1, transactions may be received from one or more source documents such as a purchase order, an invoice, a receipt, a shipping order, a receiving report, and an inventory list, and characterized in one or more dimensions. The source documents may be provided to the cost accounting system by the users through a document entry user interface that provides data entry fields or via a web-browser enabled form that accepts data entry and enables indirect and direct access to the source document by the cost accounting system.

In an example scenario, upon receipt of the transactions from the source documents, the data associated with the transactions may be characterized in one or more dimensions, for example a location dimension. Location dimensions units may be defined along with characterizing attributes including a site location, a warehouse location, and a rack location. A location unit dimension may be first defined, where the location unit may be for example, Loc #1. The location unit may be characterized by an attribute for a site, and its value, Site #1. A sub-level, or child unit, of the location unit, Loc #1, may also be defined, such that attributes that characterize a sub-location of the site may be defined to provide an additional level of detail. An attribute characterizing the sub-location of the site may be an attribute for a warehouse. For instance, a location unit dimension, Loc #2, for a particular warehouse in Site #1 may be defined as a sub-location of the Site #1 dimension, and may be characterized by the site attribute and its value, Site #1, and the warehouse attribute and its value, Wrh #1.

Table 1 below demonstrates example of transaction data characterized in one or more dimensions.

TABLE 1

| | | Parent | | | | |
|---|---|---|---|---|---|---|
| Model | Unit | Unit | Name | Defining Attributes | | |
| Activity Model | | | | Activity | | |
| Activity | ACT#2 | | Inventory Activities | | | |
| Activity | ACT#3 | ACT#2 | Purchase | Purchase | | |
| Activity | ACT#4 | ACT#2 | Product receipt | Product | | |
| | | | | receipt | | |
| | | | | Resource | | |
| Resource Model | | | | Category | Product | Variant |
| Resource | RES#2 | | Product | Product | | |
| Resource | RES#3 | RES#2 | Product X | Product | Product X | |
| Resource | RES#4 | RES#3 | Product X-white | Product | Product X | white |
| Location Model | | | | Site | Warehouse | Area |
| Location | LOC#1 | | NY | NY | | |
| Location | LOC#2 | LOC#1 | Broadway, NY | NY | Broadway | |
| Location | LOC#3 | LOC#2 | Broadway, | NY | Broadway | 1 |
| | | | NY - Area 1 | | | |
| Organization Model | | | | Entity | Department | |
| Organization | ORG#1 | | CEU | CEU | | |
| Organization | ORG#2 | ORG#1 | CEU-LOG | CEU | Logistic | |
| Organization | ORG#3 | ORG#2 | CEU-LOG-IN | CEU | Logistic | Inbound |

As discussed previously, Loc #1 is defined by a site attribute where the site attribute includes a value for the site, which may be NY, in the above table. Similarly, Loc #2 is defined by a site attribute and a warehouse attribute where NY is a value for the site and Broadway is a value for the warehouse. The Loc #2 unit is a sub-level of the Loc #1 unit, and automatically inherits the site attribute. The Loc #2 unit is also characterized by a warehouse attribute, where Broadway is a value for the warehouse attribute. In a further example, Loc #3 unit is a sub-level of the Loc #2 and Loc #1 units and is characterized by the combination of site, warehouse, and area attributes, and their corresponding values, site=NY, warehouse=Broadway, and area=Area 1.

In other scenarios, one or more other dimensions, such as a resource, an activity, and an organization may be used to characterize the data associated with the transactions, as seen in Table 1. For example, a resource dimension unit may include one or more defining attributes such as resource category attribute, product attribute, and variant attribute to characterize the data. An activity dimension unit may include an activity attribute and an organization dimension unit may include one or more defining attributes such as an entity attribute and a department attribute. The multidimensional characterized data may be used to in the determination of a magnitude of product cost and a product measure.

As illustrated in a diagram 200, a subsystem of a cost accounting system may be configured to determine a magnitude of product cost 202. The magnitude of product cost 202 may be based on a cost object unit 204 defined by a cost control model 206, a cost element unit 208 defined by a cost classification model 210, a date and time unit 212, and a quantity unit 214. The cost control model 206 may define a multi-dimensional scale of the cost object unit 204, where the cost object unit 204 identifies a segment to which the magnitude of product cost 202 is assigned at one or more levels of the cost control model 206. The cost object unit 204 may include a cost inventory object, a cost accumulation object, a cost consumer object, and/or a cost pool object, for example. Each level of the cost control model may be configured to define one or more attributes 218 and one or more attribute values 220 to characterize the segment identified as the cost object unit based on one or more dimensions 216 in order to define the multidimensional scale. The dimensions may include an activity, a resource, a location, and an organization. Each level of the cost control model 206 may be further configured to define a subset 222, or sub-unit, of the one or more attributes 218 and the one or more attribute values 220 based on the dimensions 216 to provide an additional level of detail in order to further define the multidimensional scale.

Table 2 below demonstrates an example cost control model defining a multidimensional scale of a cost object unit.

TABLE 2

| | | Parent | Scale | | | | | |
|---|---|---|---|---|---|---|---|---|
| Model | Unit | Unit | Level | Name | Defining Attributes | | | |
| Cost Control Model | | | | | Organization | Activity | Resource | Location |
| Cost Object | CO#1 | | 1 | CEU-Cost CTL | ORG#1 | | | |
| Cost Object | CO#2 | CO#1 | 2 | CEU-Inv | ORG#1 | ACT#2 | | |
| Cost Object | CO#3 | CO#2 | 3 | CEU-INV- | ORG#1 | ACT#2 | RES#3 | LOC#2 |
| | | | | Broadway NY, | | | | |
| | | | | product X | | | | |
| Cost Object | CO#4 | CO#2 | 3 | CEU-INV- | ORG#1 | ACT#2 | RES#3 | LOC#5 |
| | | | | Broadway NY, | | | | |
| | | | | product X | | | | |

For example, cost object CO #3, for identifying a magnitude of product cost of inventory activities (Activity Unit=ACT #2) conducted by entity CEU (Organization unit=ORG #1) for stock of product X (product unit=RES #3) at the Broadway warehouse at the New York Site (Location unit=LOC #2) may be defined as follows: Cost object unit CO #3 may be a sub-unit of the cost object unit CO #2 representative of inventory activities conducted by the entity CEU. Therefore CO #3 may be defined as a combination of attributes and values inherited from its parent unit CO #2, which may be Activity Unit ACT #2 and Organization Unit ORG #1, and attributes characterizing sub-unit CO #3, which may be Resource Unit RES #3 and Location Unit Loc #2 as seen above in Table 2.

Similarly, the cost classification model 210 may define a multi-dimensional scale of the cost element unit 208, where the cost element unit 208 classifies the magnitude of product cost 202 based on a value cost identified by the cost classification model 210 at one or more levels. The cost element unit 208 may include a material cost, a purchase cost, a landing cost, a labor cost, an expense, an outsourcing cost, and/or an overheads cost, for example. Each level of the cost classification model may be configured to define one or more attributes 218 and one or more attribute values 220 to characterize the segment identified as the cost element unit based on one or more of the dimensions 216 in order to define the multidimensional scale. The dimensions may include an activity and a resource. Each level of the cost classification model 210 may be further configured to define a subset 222, or sub-unit, of the one or more attributes 218 and the one or more attribute values 220 based on the resource dimension to provide an additional level of detail in order to further define the multidimensional scale.

Table 3 below demonstrates an example cost classification model defining a multidimensional scale for one or more cost element units.

TABLE 3

| | | Parent | Scale | | | |
|---|---|---|---|---|---|---|
| Model | Unit | Unit | Level | Name | Defining Attributes | |
| Cost Classification Model | | | | | Activity | Resource |
| Cost | CE#1 | | 1 | Material | | |
| Element | | | | Expenditures | | |
| Cost | CE#2 | CE#1 | 2 | Material purchase | ACT#2 | item |
| Element | | | | cost | | |
| Cost | CE#3 | CE#2 | 3 | Recreational | ACT#2 | item |
| Element | | | | goods purchase | | |
| | | | | cost | | |
| Cost | CE#4 | CE#2 | 3 | Professional | ACT#2 | item |
| Element | | | | goods purchase | | |
| | | | | cost | | |

For example, cost element CE #3, named “Recreational goods purchase cost” for classifying a cost of inventory activities (Activity Unit=ACT #2) for an item (Resource Unit=item) may be defined as follows: Cost element unit CE #3 may be a sub-unit of the cost element unit CE #2 representative of inventory activities. Therefore CE #3 may be defined as a combination of attributes and values inherited from its parent unit CE #2, which may be Activity Unit ACT #2, and attributes characterizing sub-unit CE #3, which may be Resource Unit item as seen above in Table 3.

In a system according to embodiments, defining multidimensional scales may be applicable to characterizing other models and derived measurements in other transactions and systems. The multidimensional scales may define a collection of hierarchical units for a defined measurement of the tracked system, where each defined unit may represent a tracked piece of data and includes multiple levels and sub-levels. As described above, each unit may be characterized by a combination of attributes and attribute values at a given level in the hierarchy, where each sub-level provides additional levels of detail related to the transaction data.

The date and time unit 212 may be identified by an accounting calendar selected for the reporting ledger 226 to position the magnitude of product cost 202 on a time scale. The quantity unit 214 may be identified by a reporting currency selected for the reporting ledger 226 to quantify the magnitude of product cost 202 on a monetary scale. The multidimensional scales of the cost object unit 204 and cost element unit 208, the time scale, and the monetary scale used to determine the magnitude of product cost 202 may comprise one or more scales 224 defined for cost accounting in the reporting ledger 226.

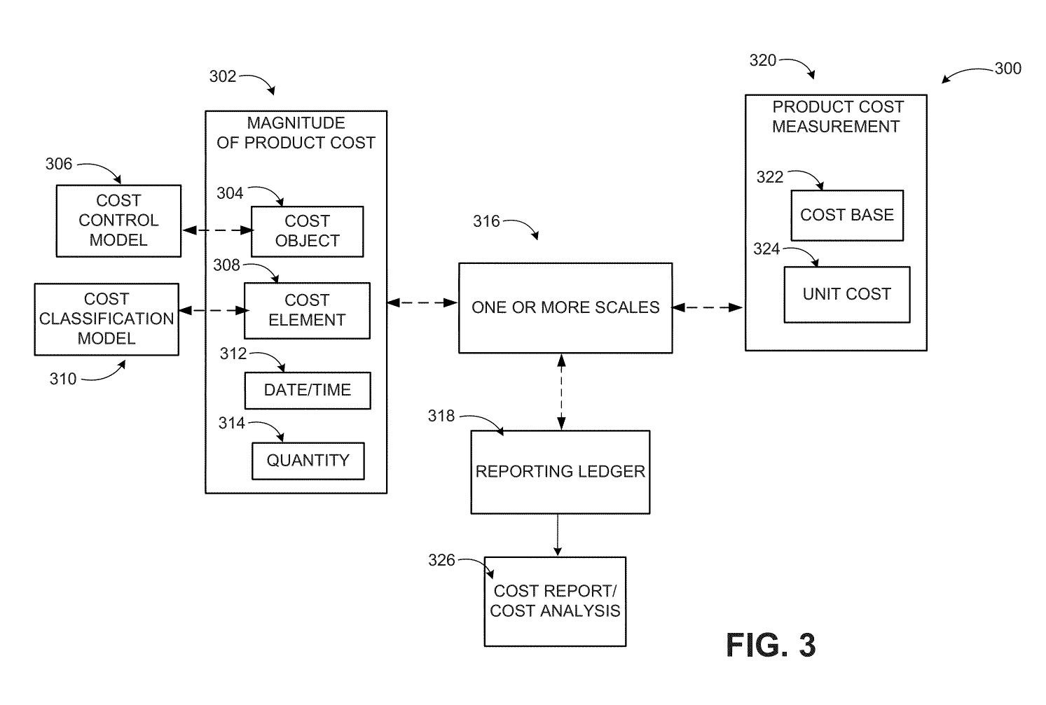

FIG. 3 illustrates an example cost accounting system where multidimensional measurement basis may be leveraged for cost accounting, according to some embodiments herein.

As illustrated in a diagram 300, a cost accounting system may include a first subsystem, a second subsystem, and a third subsystem. The first subsystem may be configured to determine a magnitude of product cost 302, the second subsystem may be configured to determine a product cost measure 320, and the third subsystem may be configured to define one or more scales 316 for units of measure that apply to cost accounting in a reporting leger 318 of the cost accounting system.

In the first subsystem, the magnitude of product cost 302 may be based on a cost object unit 304 defined by a cost control model 306, a cost element unit 308 defined by a cost classification model 310, a date and time unit 312, and a quantity unit 314. The cost control model 306 may define a multi-dimensional scale of the cost object unit 304, where the cost object unit 304 identifies a segment to which the magnitude of product cost 302 is assigned at one or more levels of the cost control model 306. Each level of the cost control model may be configured to define one or more attributes and one or more attribute values to characterize the segment identified as the cost object unit based on an activity, a resource, a location, and/or an organization.

The cost classification model 310 may define a multi-dimensional scale of the cost element unit 308, where the cost element unit 308 classifies the magnitude of product cost 302 based on a value cost identified by the cost classification model 310 at one or more levels. Each level of the cost classification model may be configured to define one or more attributes and one or more attribute values to characterize the segment identified as the cost element unit based on an activity and/or a resource.

The date and time unit 312 may be identified by an accounting calendar selected for the reporting ledger 318 to position the magnitude of product cost 302 on a time scale. The quantity unit 314 may be identified by a reporting currency selected for the reporting ledger 318 to quantify the magnitude of product cost 302 on a monetary scale. The multidimensional scales of the cost object unit 304 and cost element unit 308, the time scale, and the monetary scale used to determine the magnitude of product cost 302 may comprise one or more scales 316 defined for unit measures that apply to cost accounting in the reporting ledger 318.

In the second subsystem, the product cost measure 320 may be determined based on a cost base 322 and a unit cost 324. The product cost measure 320 is a derived measure using a formula: Product cost=(cost base*unit cost). The cost base 322 and unit cost 324 may be operands assigned from measurements and or balances of measurements according to one or more rules. For example, the measurements may be defined by one or more of the multidimensional scales of the cost object unit 304 and cost element unit 308, the time scale, and the monetary scale used to determine the magnitude of product cost 302. The second subsystem may convert the determined magnitude of product cost 302 expressed on the units that characterize the output of the product cost equation to convert the magnitude in the cost accounting referential.

In the third subsystem, one or more scales 316 may be defined for units of measure that apply to cost accounting in the reporting ledger 318 based on the magnitude of product cost 302 and product cost measure 320. The defined scales may include the multidimensional scales of the cost object unit 304 and cost element unit 308, the time scale, and the monetary scale used to determine the magnitude of product cost 302. The defined scales may enable a uniform multidimensional measurements throughout the cost accounting system. The general ledger may generate comprehensive data reports, such as cost reports 326 for cost analysis using the uniform multidimensional measurements.

The example models, systems, and subsystems depicted in FIGS. 1-3 are provided for illustration purposes only. Embodiments are not limited to the configurations and content shown in the example diagrams, and may be implemented using other models, systems, and subsystems employing the principles described herein. Furthermore, while example embodiments have been described using cost accounting for illustration purposes, leveraging multidimensional measurement basis for transactional systems may also be implemented in stock accounting, financial accounting, and comparable systems.

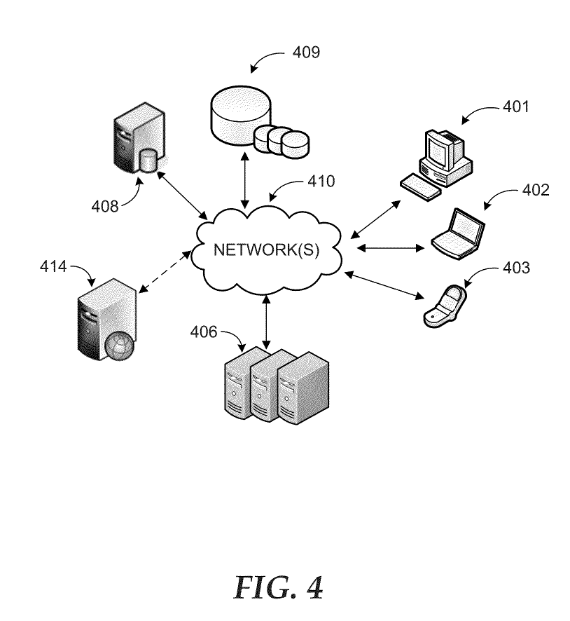

FIG. 4 is an example networked environment, where embodiments may be implemented. In addition to locally installed applications, a multidimensional measurement application enabling definition of one or more scales for units of measure that apply to the cost accounting in a reporting ledger may also be employed in conjunction with hosted applications and services that may be implemented via software executed over one or more servers 406 or individual server 414. A hosted service or application may communicate with client applications on individual computing devices such as a handheld computer, a desktop computer 401, a laptop computer 402, a smart phone 403, a tablet computer (or slate), (‘client devices’) through network(s) 410 and control a user interface presented to users.

Client devices 401-403 may be used to access the functionality provided by the hosted service or application. One or more of the servers 406 or individual server 414 may be used to provide a variety of services as discussed above. Relevant data may be stored in one or more data stores (e.g., data store 409), which may be managed by any one of the servers 406 or by database server 408.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared, and other wireless media.

Many other configurations of computing devices, applications, data sources, and data distribution systems may be employed to implement a system to leverage a multidimensional measurement basis for cost accounting. Furthermore, the networked environments discussed in FIG. 4 are for illustration purposes only. Embodiments are not limited to the example computing devices, applications, data sources, and data distribution systems.

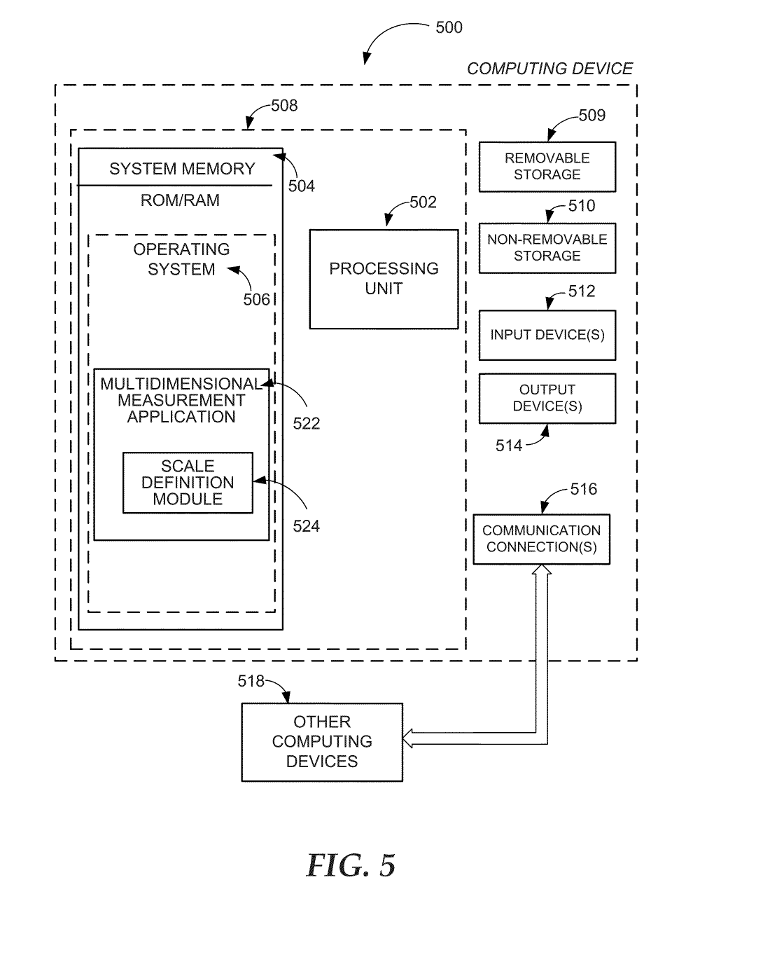

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, a computing device 500 may be any of the example devices discussed herein, and may include at least one processing unit 502 and a system memory 504. The computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS ®, WINDOWS MOBILE®, or WINDOWS PHONE® operating systems from MICROSOFT CORPORATION of Redmond, Wash. The system memory 504 may also include one or more software applications such as program modules 506, a multidimensional measurement application 522 and a scale definition module 524.

The scale definition module 524 may operate in conjunction with the operating system 506 and the multidimensional measurement application 522 to define one or more scales for units of measure that apply to cost accounting in a reporting ledger of a cost accounting system based on a determined magnitude of product cost and product cost measure. This basic configuration is illustrated in FIG. 5 by those components within dashed line 508.

The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

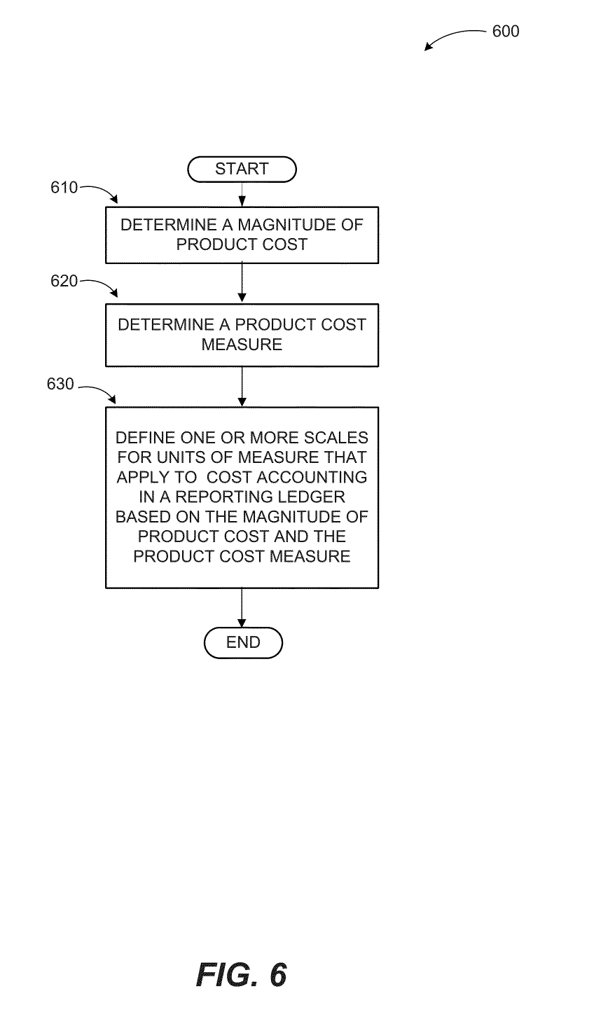

FIG. 6 illustrates a logic flow diagram for a process to leverage a multidimensional measurement basis for cost accounting. Process 600 may be implemented as part of an application or an operating system.

Process 600 begins with operation 610, “DETERMINE A MAGNITUDE OF PRODUCT COST,” where a magnitude of product cost is determined based on a cost object unit, a cost element unit, a date and time unit, and a quantity unit. A cost control model may define a multi-dimensional scale of the cost object unit, where the cost object unit identifies a segment to which the magnitude of product cost is assigned at one or more levels of the cost control model. A cost classification model may define a multi-dimensional scale of the cost element unit, where the cost element unit classifies the magnitude of product cost based on a value cost identified by the cost classification model at one or more levels. The date and time unit may be identified by an accounting calendar to position the magnitude of product cost on a time scale. The quantity unit may be identified by a reporting currency to quantify the magnitude of product cost on a monetary scale.

Operation 610 is followed by operation 620, “DETERMINE A PRODUCT COST MEASURE,” where a product cost measure is determined based on a cost base and a unit cost. The product cost measure may be derived by multiplying the cost base and the unit cost, where the cost base and unit cost are operands assigned from measurements and or balances of measurements according to one or more rules. For example, the measurements may be defined by the multidimensional scales of the cost object unit and cost element unit, the time scale, and/or the monetary scale used to determine the magnitude of product cost.

Operation 620 is followed by operation 630, “DEFINE ONE OR MORE SCALES FOR UNITS OF MEASURE THAT APPLY TO COST ACCOUNTING IN A REPORTING LEDGER BASED ON THE MAGNITUDE OF PRODUCT COST AND THE PRODUCT COST MEASURE,” where one or more scales for units of measure are defined based on the magnitude of product cost and the product cost measure. The scales may include the multidimensional scales of the cost object unit and cost element unit, the time scale, and the monetary scale used to determine the magnitude of product cost. The scales may apply to cost accounting in a reporting ledger of a cost accounting system, where the scales enable uniform multidimensional measurements to be used throughout the cost accounting system. The reporting ledger may generate comprehensive data reports for cost analysis using the uniform multidimensional measurements.

In some embodiments, a model that defines a multi-dimensional scale may be used to define at least one attribute and a related value based on one or more dimensions and units of other scales or models. For example, the cost control model may define a cost object unit using as defining attribute of the resource dimension of a resource scale and that scale's units (RES #1 . . . RES #n) as related defining attribute values. In other embodiments, operations and conversion of measurements that are expressed on an individual nominal scale may be handled consistently for product quantity measure on a resource dimension. For example, a measurement may be expressed on a multidimensional dimensional scale, for product cost measure on cost object dimension. This is similar to surface measurements on a square meter scale, which is outcome of multiplying the distance measure measurements of length and width dimensions, on a meter scale.

The operations included in process 600 are for illustration purposes. Leveraging a multidimensional measurement basis for cost accounting according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to leverage a multidimensional measurement basis for cost accounting, the method comprising:
determining a magnitude of product cost based on a cost object unit, a cost element unit, a date and time unit, and a quantity unit;
determining a product cost measure based on a cost base and a unit cost; and
defining one or more scales for units of measure that apply to the cost accounting in a reporting ledger based on the magnitude of product cost and the product cost measure.

2. The method of claim 1, further comprising:
defining a multidimensional scale of the cost object unit at a cost control model selected for the reporting ledger.

3. The method of claim 2, wherein the cost object unit identifies a segment to which the magnitude of product cost is assigned at one or more levels of the cost control model.

4. The method of claim 3, wherein each level of the cost control model is configured to define one or more attributes and one or more attribute values to characterize the segment identified as the cost object unit based on one or more dimensions in order to define the multidimensional scale.

5. The method of claim 4, wherein each level of the cost control model is further configured to define a subset of the one or more attributes and the one or more attribute values based on the one or more dimensions in order to further define the multidimensional scale.

6. The method of claim 4, wherein the one or more dimensions include a resource, an activity, a location, and an organization of the segment identified as the cost object unit.

7. The method of claim 1, further comprising:
defining a multidimensional scale of the cost element unit at a cost classification model selected for the reporting ledger.

8. The method of claim 7, wherein the cost element unit classifies the magnitude of product cost based on a value cost identified by the cost classification model at one or more levels.

9. The method of claim 8, wherein each level of the cost classification model is configured to define one or more other attributes and one or more other attribute values to characterize the value cost identified as the cost element unit based on one or more of a resource and an activity.

10. The method of claim 9, wherein each level of the cost classification model is further configured to define a subset of the one or more other attributes and the one or more other attribute values based on the resource.

11. The method of claim 1, further comprising:
identifying the date and time unit at an accounting calendar selected for the reporting ledger, wherein the date and time unit positions the magnitude of product cost on a time scale.

12. The method of claim 1, further comprising:
identifying the quantity unit at a reporting currency selected for the reporting ledger, wherein the quantity unit quantifies the magnitude of product cost on a monetary scale.

13. The method of claim 1, wherein determining the product cost measure based on a cost base and a unit cost further comprises:
multiplying the cost base and the unit cost to determine the product cost measure.

14. A system to leverage a multidimensional measurement basis for cost accounting, the system comprising:
a first subsystem configured to determine a magnitude of product cost based on a cost object unit, a cost element unit, a date and time unit, and a quantity unit, the first subsystem comprising:
a cost control model configured to define a multidimensional scale of the cost object unit that identifies a segment to which the magnitude of product cost is assigned;
a cost classification model configured to define a multidimensional scale of the cost element unit that classifies the magnitude of product cost;
an accounting calendar configured to identify the date and time unit that positions the magnitude of product cost on a time scale; and
a reporting currency configured to identify the quantity unit that quantifies the magnitude of product cost on a monetary scale;
a second subsystem configured to determine a product cost measure based on a cost base and a unit cost by multiplying the cost base and the unit cost in a product cost formula; and
a third subsystem configured to define one or more scales for units of measure that apply to the cost accounting in a reporting ledger based on the magnitude of product cost and the product cost measure.

15. The system of claim 14, wherein a model that defines a multi-dimensional scale is used to define at least one attribute and a related value based on one or more dimensions and units of other scales or models.

16. The system of claim 15, wherein operations and conversion of measurements that are expressed on an individual nominal scale are handled consistently for product quantity measure on a resource dimension.

17. The system of claim 14, wherein
the cost object unit comprises one or more of a cost inventory object, an cost accumulation object, a cost consumer object, and a cost pool object, and
the cost element unit comprises one or more of a material cost, a purchase cost, a landing cost, a labor cost, an expense, an outsourcing cost, and an overheads cost.

18. The system of claim 14, wherein
the cost base and the unit cost are operands in the product cost formula to which one of measurements and balance of measurements are assigned according to one or more rules, and
the one or more scales are defined from one or more of the multidimensional scale of the cost object unit, the multidimensional scale of the cost element unit, the time scale, and the monetary scale.

19. A computer-readable memory device with instructions stored thereon to leverage a multidimensional measurement basis for cost accounting, the instructions comprising:
determining a magnitude of product cost based on a cost object unit, a cost element unit, a date and time unit, and a quantity unit;
determining a product cost measure based on a cost base and a unit cost; and
defining one or more scales for units of measure that apply to the cost accounting in a reporting ledger based on the magnitude of product cost and the product cost measure.

20. The computer-readable memory device of claim 19, further comprising:
generating a report from the reporting ledger, wherein the report enables data analysis based on the one or more scales defined.
